(19) United States
(12) Patent Application Publication
(10) Pub. No.: US 2008/0214189 A1
(43) Pub. Date: Sep. 4, 2008

(54) MOBILITY PROTOCOL SWITCHING FOR WIRELESS NETWORKS

(76) Inventor: Pouya Taaghol, San Jose, CA (US)

Correspondence Address: KACVINSKY LLC;C/O INTELLEVATE, P.O. BOX 52050, MINNEAPOLIS, MN, 55402, US

(21) Appl. No.: 11/680,790

(22) Filed: Mar. 1, 2007

(51) Int. Cl. H04Q 7/20

(52) U.S. Cl. 455/432.2

(57) ABSTRACT

Techniques for mobility protocol switching for wireless networks are described. An apparatus may comprise a convergence gateway having a protocol converter, the protocol converter to receive as input a first set of control plane protocol signals and a first set of user plane protocol signals from a first network, convert the first set of control plane protocol signals to a second set of control plane protocol signals and the first set of user plane protocol signals to a second set of user plane protocol signals, and to send as output the second set of control plane protocol signals and the second set of user plane protocol signals to a second network. Other embodiments are described and claimed.

### BACKGROUND

Wireless communication systems communicate information over a shared wireless communication medium such as one or more portions of the radio-frequency (RF) spectrum. Typically, different wireless service providers operate and maintain wireless networks for different geographic regions. While traveling, a subscriber for a first wireless service provider may enter the wireless network of a second wireless service provider. In many cases, the subscriber does not have a service agreement with the second wireless service provider. Through a relatively complex set of service agreements maintained between various service providers, however, the subscriber may be allowed to use the services for the second wireless network despite the absence of a subscriber agreement with the second wireless service provider. In this case the subscriber is considered to be “roaming” outside of their home network. One of the many challenges in handling roaming subscribers, however, is providing the same or similar set of services provided by the home network. Consequently, there may be a need for improved techniques to manage roaming for wireless devices or networks.

### BRIEF DESCRIPTION OF THE DRAWINGS

FIG. 1 illustrates one embodiment of a communications system.

FIG. 2 illustrates one embodiment of a convergence gateway.

FIG. 3 illustrates one embodiment of first message flow.

FIG. 4 illustrates one embodiment of a second message flow.

FIG. 5 illustrates one embodiment of a third message flow.

FIG. 6 illustrates one embodiment of a fourth message flow.

FIG. 7 illustrates one embodiment of a logic flow.

FIG. 8 illustrates one embodiment of an article of manufacture.

### DETAILED DESCRIPTION

Various embodiments may be generally directed to techniques for mobility protocol switching for heterogeneous wireless networks. For example, some embodiments may provide an Internet Engineering Task Force (IETF) network based mobility protocol switching with a General Packet Radio Service (GPRS) Tunneling Protocol (GTP) functionality to offer seamless roaming of Worldwide Interoperability for Microwave Access (WiMAX) devices on Third Generation Partnership Project (3GPP) networks. Some embodiments can be implemented in a 3GPP network to allow seamless roaming of WiMAX devices over existing 3GPP roaming infrastructure with little or no change to the 3GPP roaming infrastructure or the WiMAX devices. In this manner, the mobility protocol switching techniques may be used to improve roaming operations for wireless devices or networks.

In one embodiment, for example, an apparatus may comprise a convergence gateway having a protocol converter. The protocol converter may be arranged to receive as input a first set of control plane protocol signals and a first set of user plane protocol signals from a first network, convert the first set of control plane protocol signals to a second set of control plane protocol signals and the first set of user plane protocol signals to a second set of user plane protocol signals, and to send as output the second set of control plane protocol signals and the second set of user plane protocol signals to a second network. Other embodiments are described and claimed.

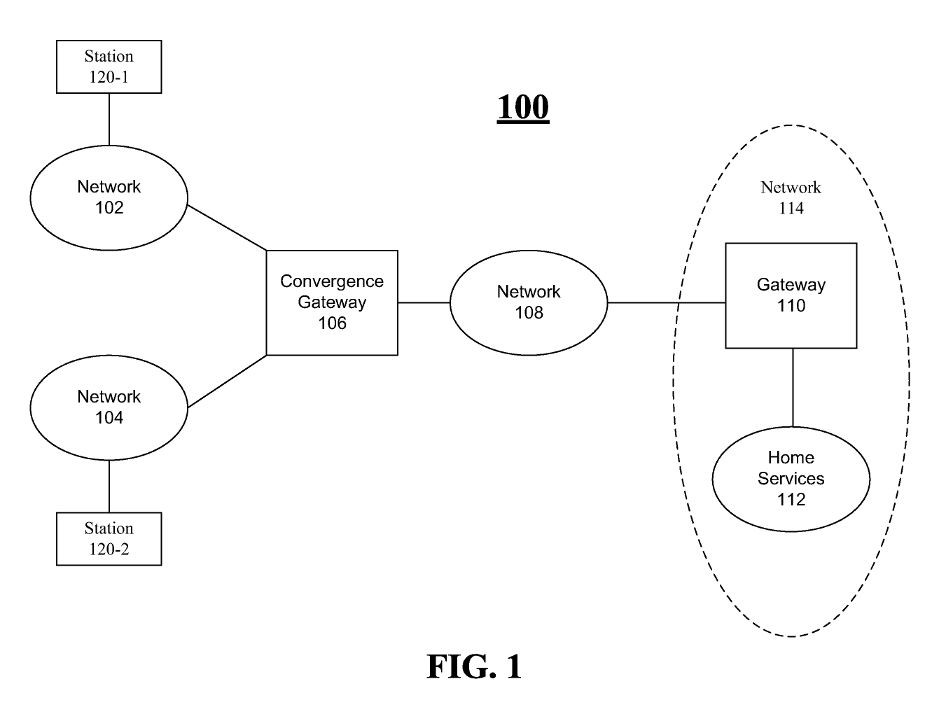

FIG. 1 illustrates a block diagram of one embodiment of a communications system 100. In various embodiments, the communications system 100 may comprise multiple nodes. A node generally may comprise any physical or logical entity for communicating information in the communications system 100 and may be implemented as hardware, software, or any combination thereof, as desired for a given set of design parameters or performance constraints. Although the communications system 100 illustrates a limited number of nodes and networks arranged in a particular topology by way of example, it may be appreciated that the communications system 100 may include additional nodes and networks, or fewer nodes and networks, and still fall within the scope of the embodiments.

In various embodiments, the communications system 100 may comprise, or form part of a wired communications system, a wireless communications system, or a combination of both. For example, the communications system 100 may include one or more nodes arranged to communicate information over one or more types of wired communication links. Examples of a wired communication link, may include, without limitation, a wire, cable, bus, printed circuit board (PCB), Ethernet connection, peer-to-peer (P2P) connection, backplane, switch fabric, semiconductor material, twisted-pair wire, co-axial cable, fiber optic connection, and so forth. The communications system 100 also may include one or more nodes arranged to communicate information over one or more types of wireless communication links. Examples of a wireless communication link may include, without limitation, a radio channel, infrared channel, radio-frequency (RF) channel, Wireless Fidelity (WiFi) channel, a portion of the RF spectrum, and/or one or more licensed or license-free frequency bands.

As shown in FIG. 1, the communications system 100 may comprise a mobile station 120-1 communicatively coupled to a network 102, and a mobile station 120-2 communicatively coupled to a network 104. The mobile stations 120-1, 120-2 are wireless devices, and may move to different networks than shown in FIG. 1. The networks 102, 104 may be communicatively coupled to a convergence gateway 106. The convergence gateway 106 may be communicatively coupled to a gateway 110 via a network 108. The gateway 110 may be communicatively coupled to home services 112, both of which are part of a network 114. The embodiments are not limited in this context.

In various embodiments, the mobile stations 120-1, 120-2 may be implemented as wireless devices. Examples of wireless devices may include, without limitation, a station, a mobile station, a subscriber mobile station, a base mobile station, a wireless access point, a wireless client device, a wireless mobile station, a laptop computer, ultra-laptop computer, portable computer, personal computer (PC), notebook PC, handheld computer, personal digital assistant (PDA), cellular telephone, combination cellular telephone/PDA, smartphone, pager, messaging device, media player, digital music player, set-top box, appliance, workstation, user terminal, mobile unit, and so forth. In such embodiments, the mobile stations 120-1, 120-2 may comprise one more wireless interfaces and/or components for wireless communication such as one or more transmitters, receivers, transceivers, chipsets, amplifiers, filters, control logic, network interface cards, antennas, and so forth. Examples of an antenna may include, without limitation, an internal antenna, an omni-directional antenna, a monopole antenna, a dipole antenna, an end fed antenna, a circularly polarized antenna, a micro-strip antenna, a diversity antenna, a dual antenna, an antenna array, and so forth.

In various embodiments, the networks 102, 114 may each represent cellular radiotelephone systems. In one embodiment, for example, the networks 102, 114 may represent cellular radiotelephone systems implementing techniques as defined by one or more standards promulgated by the Third Generation Partnership Project (3GPP) organization. Examples of such technologies and standards include Global System for Mobile Communications (GSM), Universal Mobile Telecommunications System (UMTS), General Packet Radio Service (GPRS), High Speed Downlink Packet Access (HSDPA), High Speed Uplink Packet Access (HSUPA), Long Term Evolution (LTE), High Speed Orthogonal Frequency Division Multiplexing Packet Access (HSOPA), and so forth. It may be appreciated, however, that the networks 102, 114 may be implemented as different cellular radiotelephone systems other than 3GPP systems. The embodiments are not limited in this context.

In various embodiments, the network 104 may represent a non-3GPP network, such as a broadband wireless architecture as standardized by the Institute of Electrical and Electronics Engineers (IEEE) 802.16 Working Group (WG) and the Worldwide Interoperability for Microwave Access (WiMAX) forum. The 802.16 WG is developing a series of standards for the Physical (PHY) and medium access control (MAC) layers, as well as for the security and higher-layer network model. The terms 802.16 and WiMAX as used herein may be interchangeable. In such an embodiment, the wireless network 104 may communicate information in accordance with one or more of the IEEE 802.16 series of standards for WiMAX and associated protocols, such as the IEEE standards 802.16-2004, 802.16.2-2004, 802.16e-2005, 802.16f, and variants It may be appreciated, however, that the network 104 may be implemented as different wireless networking systems other than a WiMAX system. For example, the network 104 may be implemented in accordance with the IEEE 802.11 standard (1999 Edition, Information Technology Telecommunications and Information Exchange Between Systems—Local and Metropolitan Area Networks—Specific Requirements, Part 11: WLAN Medium Access Control (MAC) and Physical (PHY) Layer Specifications), its progeny and supplements thereto (e.g., 802.11 a, b, g/h, j, n, and variants), the IEEE 802.20 series of standards, as well as other wireless networking standards. The embodiments are not limited in this context.

In various embodiments, the network 104 may implement various IETF protocols. In one embodiment, for example, the network 104 may implement a Mobile Internet Protocol (MIP) protocol as defined by the IETF series of standards, such as the IETF Request For Comment (RFC) 3344 titled “IP Mobility Support for IPv4,” August 2002; the IETF Internet Draft titled “A Protocol for Network-based Localized Mobility Management,” Dec. 5, 2006, the IETF Internet Draft titled “Mobility Management using Proxy Mobile IPv4,” Jun. 25, 2006; as well as progeny, variants, and others (collectively referred to as the “MIP Standard”). The MIP Standard defines an IETF standard communications protocol that is designed to allow mobile device users to move from one network to another while maintaining a permanent IP address. The MIP protocol provides an efficient, scalable mechanism for roaming within the Internet. Using the MIP protocol, nodes may change their point-of-attachment to the Internet without changing their IP address. This allows them to maintain transport and higher-layer connections while moving. Node mobility is realized without the need to propagate host-specific routes throughout the Internet routing fabric.

In brief, a mobile node such as the mobile stations 120-1, 120-2 can have two addresses, including a permanent home address and a care-of address, which is associated with the network the mobile node is visiting. There are two kinds of entities in the MIP Standard, including a home agent to store information about mobile nodes whose permanent address is in the home agent's network, and a foreign agent to store information about mobile nodes visiting its network. Foreign agents also advertise care-of addresses, which are used by the MIP protocol. A node wanting to communicate with the mobile node uses the home address of the mobile node to send packets. These packets are intercepted by the home agent, which uses a table and tunnels the packets to the mobile node's care-of address with a new IP header, preserving the original IP header. The packets are decapsulated at the end of the tunnel to remove the added IP header and delivered to the mobile node. When acting as sender, mobile node sends packets directly to the other communicating node through the foreign agent. If needed, the foreign agent could employ reverse tunneling by tunneling mobile node's packets to the home agent, which in turn forwards them to the communicating node.

In one embodiment, for example, the network 114 may comprise a 3GPP network that is a home network for the mobile stations 120-1, 120-2. The term “home network” may refer to a cellular radiotelephone system operated by a wireless service provider having a subscription agreement with the operator(s) of the mobile stations 120-1, 120-2. When operating within the communication range of the network 102, the mobile stations 120-1, 120-2 may be considered home mobile stations operating in a home mode.

In various embodiments, the network 114 may include a gateway 110 and a home services server 112. When in a roaming mode, the mobile stations 120-1, 120-2 may access the home services server 112 via the gateway 110. The gateway 110 may comprise, for example, a Gateway GPRS Support Node (GGSN). The GGSN is network node that acts as a gateway between a GPRS wireless data network and other networks such as the Internet or private networks. The GGSN is the anchor point that enables the mobility of the mobile stations 120-1, 120-2, sometimes referred to as User Equipment (UE), in the GPRS/UMTS networks. In essence, it carries out the role in GPRS equivalent to the Home Agent in the MIP Standard. It maintains routing necessary to tunnel the Protocol Data Units (PDUs) to the Serving GPRS Support Node (SGSN) that services a particular mobile subscriber. The SGSN is the node which in some sense carries out the same function as the Foreign Agent in the MIP Standard. An SGSN, however, typically does the full set of interworking with the connected radio network. This means that the functions carried out by the SGSN may vary between GSM and UMTS. Other functions for the GGSN include subscriber screening, Internet Protocol (IP) Pool management and address mapping, Quality of Service (QoS) and PDP context enforcement. It may be appreciated that the network 114 may include additional elements for a given cellular radiotelephone network, such as a GSM or UMTS network, which have otherwise been omitted herein solely for purposes of clarity.

In one embodiment, for example, the network 102 may comprise a 3GPP network that is a visited network for the mobile stations 120-1, 120-2. The term “visited network” may refer to a cellular radiotelephone system operated by a wireless service provider that does not have a subscription agreement with the operator(s) of the mobile stations 120-1, 120-2. When operating within the communications range of the network 102, the mobile stations 120-1, 120-2 may be considered roaming mobile stations operating in a roaming mode.

In one embodiment, for example, a network 108 may represent a roaming system or infrastructure to facilitate roaming operations when one or more of the mobile stations 120-1, 120-2 are operating in a roaming mode via the network 102. The network 108 may implement a roaming infrastructure that allows subscribers of one wireless service provider to roam into another wireless service provider's network. The roaming infrastructure typically implements various aspects of user traffic routing, subscriber authentication, subscriber authorization, settlement, clearing services, and so forth. In most roaming scenarios, for example, data packets from the mobile stations 120-1, 120-2 need to travel between the visited network and the subscriber's home network in order to access any home services, represented as home services 112 of the network 114. To accomplish this, the network 108 may implement a roaming exchange as defined by the 3GPP standards, referred to as the GPRS Roaming Exchange (GRX). The GRX may allow roaming operations between partner operators based on the GPRS Tunneling Protocol (GTP). Various GTP protocols may be defined in detail by the 3GPP standard TS 29.060 titled “General Packet Radio Service (GPRS); GPRS Tunneling Protocol (GTP) across the Gn and Gp interface,” Release 1999 and subsequent versions.

Although the network 108 may be utilized for roaming operations between 3GPP networks such as the networks 102, 114, the GRX of the network 108 by itself may not be suitable for facilitating roaming operations between non-3GPP networks and 3GPP networks, such as the network 104 and the network 114, for example. Enabling roaming is desirable since it allows wireless service providers to increase their WiMAX service availability to the end user. The current WiMAX and 3GPP specifications only specify use of the IETF protocols for such roaming operations. An IETF-based roaming infrastructure to support this requirement, however, is currently not available. This may delay and hinder introduction of WiMAX roaming operations between non-3GPP and 3GPP operators. Furthermore, a completely new IETF-based roaming infrastructure would impose additional costs to operators.

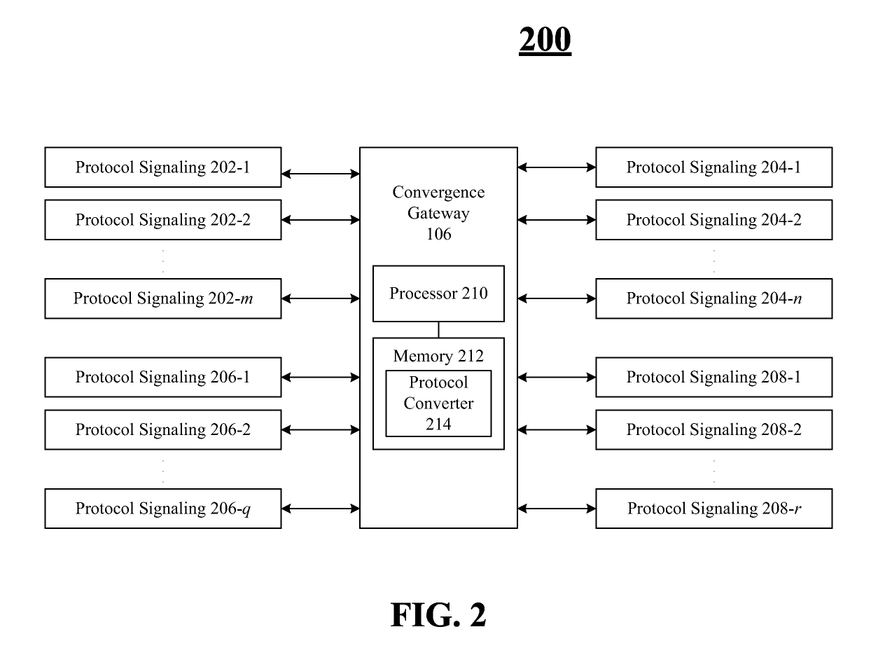

Various embodiments attempt to solve these and other problems. Various embodiments may implement a convergence gateway 106 to enable WiMAX roaming over existing GTP-based and GRX roaming infrastructure of 3GPP operators, such as provided by the network 108. For example, the mobile station 120-2 may be a roaming mobile station operating in a roaming mode when operating within communication range of the network 104. The mobile station 120-2 and the network 104, however, both utilize IETF-based protocols and interfaces for roaming and mobility. Examples of such IETF-based protocols may include Authentication, Authorization, Accounting (AAA) protocols, client-based MIP, network-based MIP, various other MIP protocols defined by the MIP Standard, and so forth. The convergence gateway 106 anchors both the 3GPP network 102 and the non-3GPP network 104 (e.g. WiMAX). The convergence gateway 106 is responsible for mobility operations between 3GPP and non-3GPP systems, including the conversion of IETF protocols to GTP protocols, and vice-versa. In one embodiment, for example, the convergence gateway 106 may perform protocol conversion operations as part of a 3GPP System Architecture Evolution (SAE) system. The convergence gateway 106 may be described in more detail with reference to FIG. 2.

FIG. 2 illustrates one embodiment of the convergence gateway 106. In one embodiment, for example, the convergence gateway 106 may include the appropriate hardware and/or software interfaces to communicate information with a 3GPP network such as the networks 102, 114, and a non-3GPP network such as the network 104. In one embodiment, for example, the convergence gateway 106 may be implemented as a processing system (e.g., a server) including a processor 210 and a memory unit 212. The processing system may be arranged to execute a protocol converter 214 implemented as a software element. It may be appreciated, however, that the protocol converter 214 may be implemented using hardware elements as well, or a combination of hardware elements and software elements, as desired for a given implementation. The embodiments are not limited in this context.

In general operation, the convergence gateway 106 may be arranged to perform protocol conversion operations for the communications system 100. More particularly, the convergence gateway 106 may be arranged to translate a first set of protocols to a second set of protocols, and vice-versa. Examples for the first set of protocols may include various non-3GPP protocols, such as various IETF protocols including WiMAX protocols. Examples for the second set of protocols may include various 3GPP protocols, such as GTP and GRX protocols.

In one embodiment, for example, the convergence gateway 106 may include a protocol converter 214. The protocol converter 214 may receive as input a first set of control plane protocol signals and a first set of user plane protocol signals via a first network, such as the network 104, from the mobile station 120-2. The protocol converter 214 may convert the first set of control plane protocol signals to a second set of control plane protocol signals, and the first set of user plane protocol signals to a second set of user plane protocol signals. The protocol converter 214 may send as output the second set of control plane protocol signals and the second set of user plane protocol signals to a second network, such as the network 114. In this manner, the mobile station 120-2 may access the home services provided by the home services provider 112 of the network 114 via the GGSN 110.

As shown in FIG. 2, the protocol converter 214 of the convergence gateway 106 may receive as input a first set of control plane protocol signals 202-1-m, and a first set of user plane protocol signals 206-1-q, where m and q are positive integers not necessarily representing the same value. For example, the protocol signals 202-1-m, 206-1-q may each represent various IETF protocols including WiMAX protocols, such as the AAA and MIP Standard protocols.

In various embodiments, the protocol converter 214 may convert the first set of control plane protocol signals 202-1-m to a second set of control plane protocol signals 204-1-n, and the first set of user plane protocol signals 206-1-q to a second set of user plane protocol signals 208-1-r, where n and r are positive integers not necessarily representing the same value. For example, the protocol signals 204-1-n, 208-1-r may each represent various 3GPP protocols, such as the GTP and GRX protocols.

In one embodiment, for example, the control plane protocols of IETF such as the AAA and MIP control signals are translated to GTP-control (GTP-c) signals. In one embodiment, for example, the IETF user plane protocols (e.g., GRE/IP-in-IP) are translated to GTP-user plane (GTP-u) signals. In this manner, the mapping or conversion of protocol signals of the same type may improve protocol conversion operations and overall system efficiency in terms of processing speed (MIPS) and throughput.

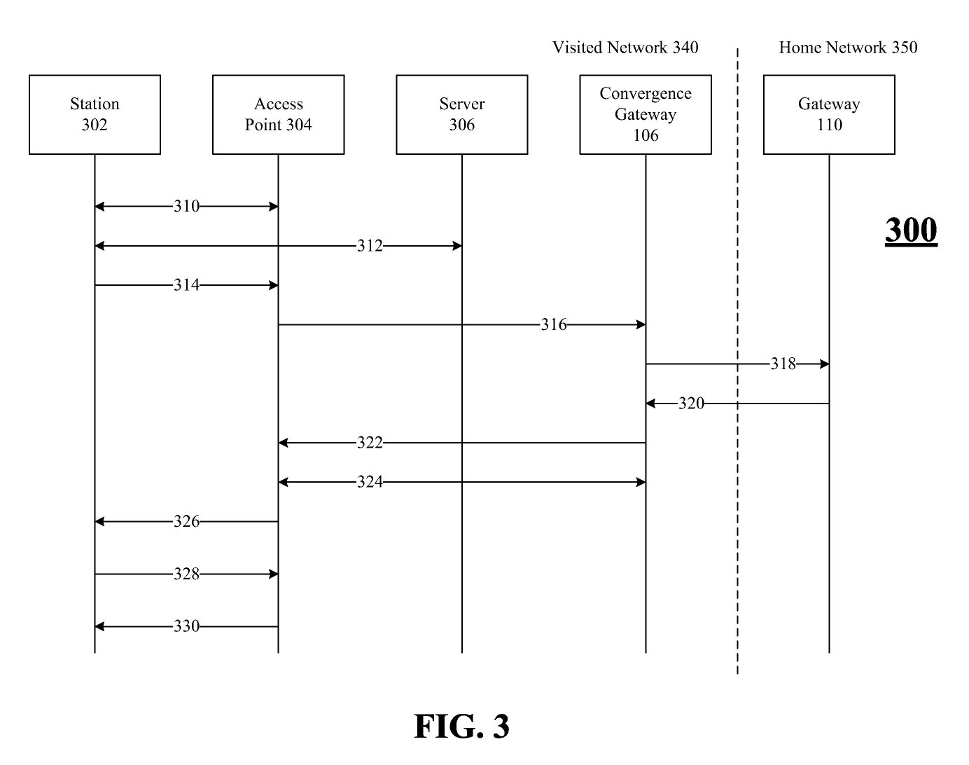

FIG. 3 illustrates one embodiment of a message flow 300. The message flow 300 may provide an example of an initial attachment procedure for roaming in a proxy MIP (PMIP) scenario. FIG. 3 illustrates a visited network 340 having a mobile station 302, an access point 304, a server 306 and the convergence gateway 106. The mobile station 302 may be representative of the mobile stations 120-1, 120-2, the access point 304 may comprise part of the network 104, and the server 306 may be representative of a 3GPP AAA proxy server. FIG. 3 further illustrates a home network 350 having the gateway 110 implemented as an SGSN.

As shown in FIG. 3, a mobile station 302 may have the home network 350 and roam to the visited network 340. When roaming to the visited network 340, the mobile station 302 may interact with the access point 304 to perform non-3GPP specific procedures as indicated by arrow 310. Examples of non-3GPP specific procedures may include WiMAX network detection, network connection, authentication operations, and so forth. Once authenticated to the non-3GPP access point 304, the mobile station 302 may initiate Extendible Authentication Protocol (EAP) operations to authenticate with the server 306 as indicated by the arrow 312. Once authenticated by the server 306, the mobile station 302 may initiate Dynamic Host Configuration Protocol (DHCP) operations by sending a DHCP Discover/Solicit request message to request and obtain an IP address from the access point 304, which has a list of IP addresses available for assignment, as indicated by arrow 314.

The access point 304 may send a PMIP request message (RRQ/BU) to the convergence gateway 106 as indicated by arrow 316. The convergence gateway 106 may convert the PMIP request to a GTP create PDP context request message as indicated by arrow 318. The gateway 110 may send a GTP create PDP context response message to the convergence gateway 106 as indicated by arrow 320. The convergence gateway 106 may convert the GTP create PDP context response message to a PMIP response message (RRP/Back) as indicated by arrow 322. The convergence gateway 106 may then initiate MIP bearer tunnel setup (GRE, IP-in-IP) operations to establish a MIP bearer tunnel between the convergence gateway 106 and the access point 304 as indicated by arrow 324. Once a MIP bearer tunnel has been established, the access point 304 may send a DHCP Offer/Advertise message to the mobile station 302 as indicated by arrow 326. The mobile station 302 may send a DHCP request message to the access point 304 as indicated by arrow 328. The access point 304 may send a DHCP Ack/Reply message to the mobile station 302 as indicated by arrow 330.

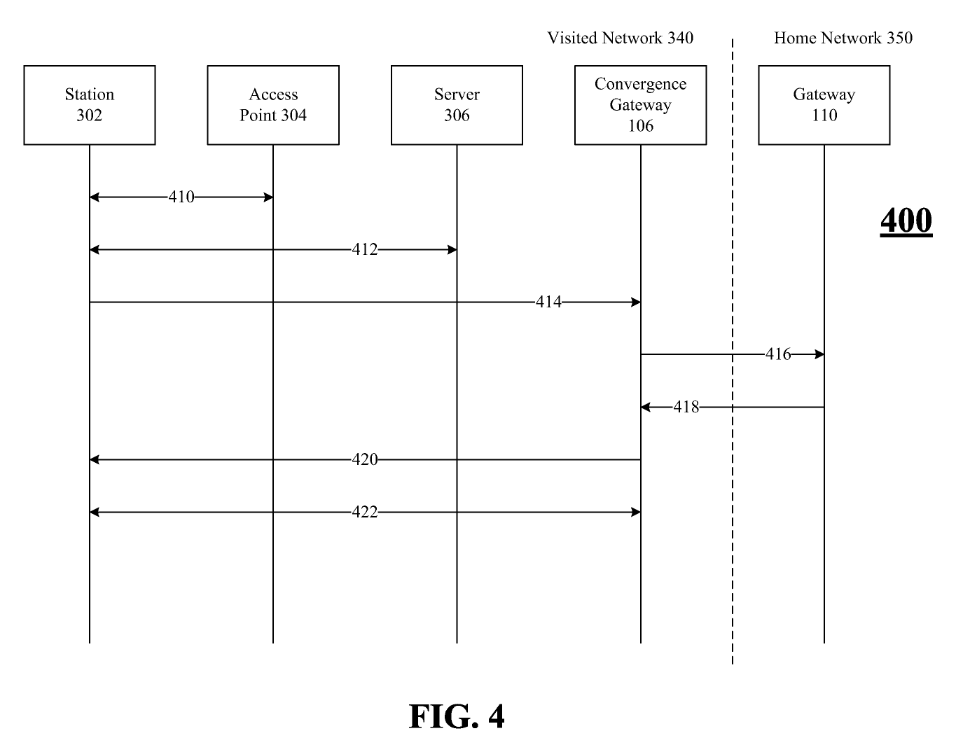

FIG. 4 illustrates one embodiment of a message flow 400. The message flow 400 may provide an example of an initial attachment procedure for roaming in a Common Management Information Protocol (CMIP) scenario. As shown in FIG. 4, the mobile station 302 may perform non-3GPP specific procedures as indicated by arrow 410. The mobile station 302 may initiate EAP authentication procedures with the server 306 as indicated by the arrow 412. The mobile station 302 may send a MIP request message (RRQ/BU) to the convergence gateway 106 as indicated by arrow 414. The convergence gateway 106 may convert the MIP request message to a GTP create PDP context request message, and send the converted GTP message to the gateway 110 as indicated by arrow 416. The gateway 110 may send a GTP create PDP context response message to the convergence gateway as indicated by arrow 418. The convergence gateway 106 may convert the GTP create PDP context response message to a MIP response message (RRP/Back), and send to the mobile station 302 as indicated by arrow 420. A MIP bearer tunnel (GRE, IP-in-IP) may be established between the mobile station 302 and the convergence gateway 106 as indicated by arrow 422.

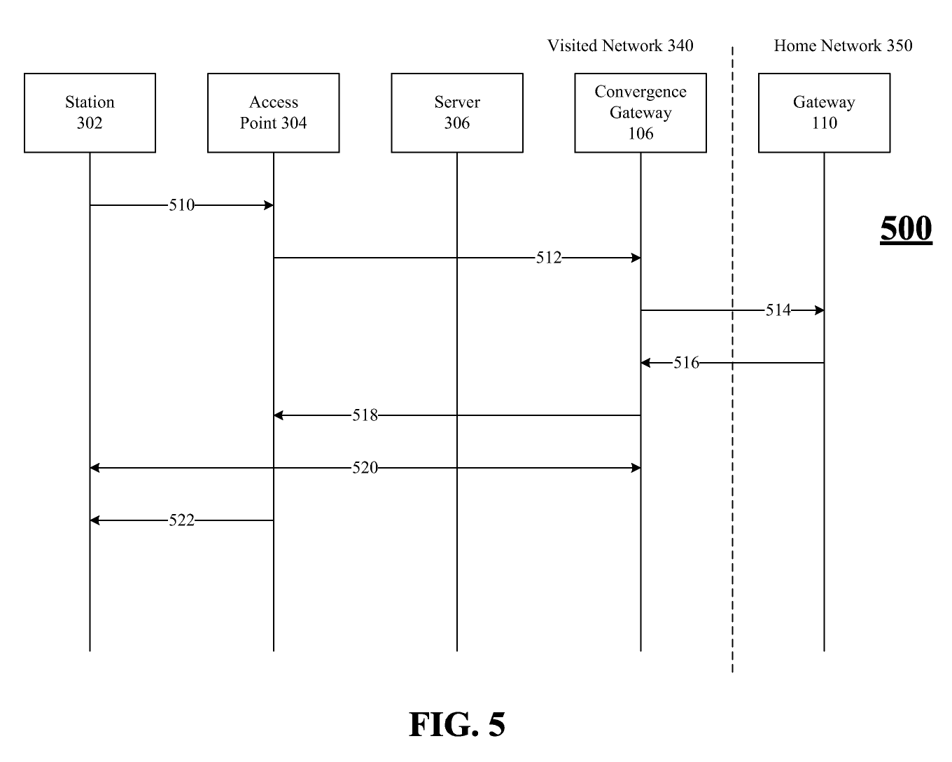

FIG. 5 illustrates one embodiment of a message flow 500. The message flow 500 may provide an example of a detachment procedure for roaming in a PMIP scenario. As shown in FIG. 5, the mobile station 302 may send a DHCP release message to the access point 304 as indicated by arrow 510. The access point 304 may send a PMIP message (De-RRQ/BU) to the convergence gateway 106 as indicated by arrow 512. The convergence gateway 106 may convert the PMIP message to a GTP delete PDP context request message, and send the converted message to the gateway 110 as indicated by arrow 514. The gateway 110 may send a GTP delete PDP context response message to the convergence gateway 106 as indicated by arrow 516. The convergence gateway 106 may convert the GTP delete PDP context response message to a PMIP message (De-RRP/Back), and send the converted message to the access point 304 as indicated by arrow 518. The MIP bearer tunnel (GRE, IP-in-IP) between the convergence gateway 106 and the access point 304 may be released as indicated by arrow 520. The access point 304 may send a DHCP response message (Ack/Reply) to the mobile station 302.

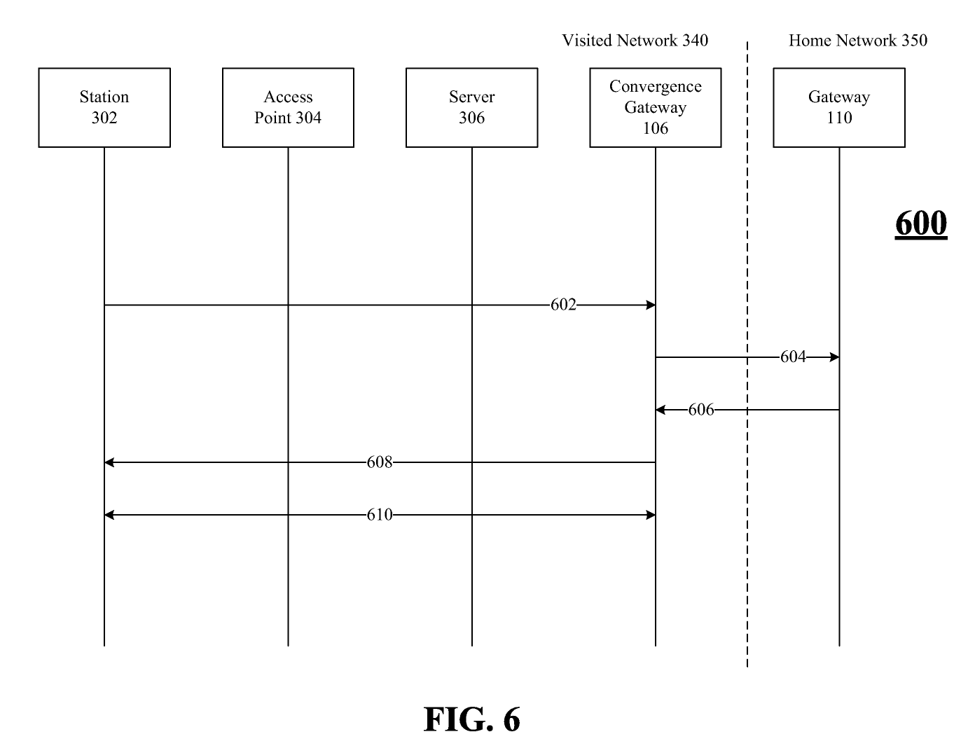

FIG. 6 illustrates one embodiment of a message flow 600. The message flow 600 may provide an example of a detachment procedure for roaming in a CMIP scenario. As shown in FIG. 6, the mobile station 302 may send a CMIP message (De-RRQ/BU) to the convergence gateway 106 as indicated by arrow 602. The convergence gateway 106 may convert the CMIP message to a GTP delete PDP context request message, and send the converted message to the gateway 110 as indicated by arrow 604. The gateway 110 may send a GTP delete PDP context response message to the convergence gateway 106 as indicated by arrow 606. The convergence gateway 106 may convert the GTP delete PDP context response message to a CMIP message (De-RRP/Back), and send the converted message to the mobile station 302 as indicated by arrow 608. The MIP bearer tunnel (GRE, IP-in-IP) between the convergence gateway 106 and the mobile station 302 may be released as indicated by arrow 610.

Operations for various embodiments may be further described with reference to the following figures and accompanying examples. Some of the figures may include a logic flow. It can be appreciated that an illustrated logic flow merely provides one example of how the described functionality may be implemented. Further, a given logic flow does not necessarily have to be executed in the order presented unless otherwise indicated. In addition, a logic flow may be implemented by a hardware element, a software element executed by a processor, or any combination thereof. The embodiments are not limited in this context.

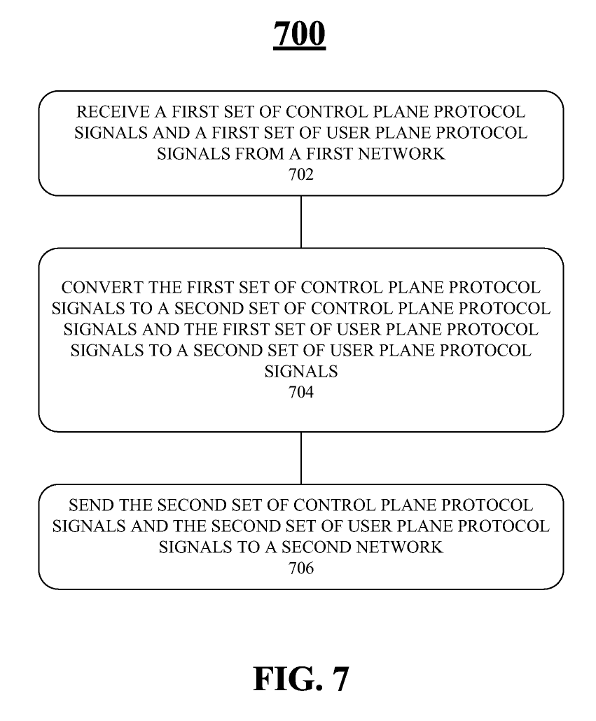

FIG. 7 illustrates one embodiment of a logic flow 700 for performing protocol conversion. In various embodiments, the logic flow 700 may be performed by various systems, nodes, and/or modules and may be implemented as hardware, software, and/or any combination thereof, as desired for a given set of design parameters or performance constraints. For example, the logic flow 700 may be implemented by a logic device (e.g., convergence gateway 106 and/or protocol converter 214) and/or logic comprising instructions, data, and/or code to be executed by a logic device. For purposes of illustration, and not limitation, the logic flow 700 is described with reference to FIG. 1. The embodiments are not limited in this context.

As shown in FIG. 7, the logic flow 700 may receive a first set of control plane protocol signals and a first set of user plane protocol signals from a first network at block 702. The logic flow 700 may convert the first set of control plane protocol signals to a second set of control plane protocol signals and the first set of user plane protocol signals to a second set of user plane protocol signals at block 704. The logic flow 700 may send the second set of control plane protocol signals and the second set of user plane protocol signals to a second network at block 706. The embodiments are not limited in this context.

In one embodiment, for example, the convergence gateway 106 may receive a first set of control plane protocol signals 202-1-m and a first set of user plane protocol signals 206-1-q from the network 104. The convergence gateway 106 may receive the first set of control plane protocol signals 202-1-m and the first set of user plane protocol signals 206-1-q from the roaming mobile station 302. The embodiments are not limited in this context.

In one embodiment, for example, the convergence gateway 106 may convert the first set of control plane protocol signals 202-1-m to a second set of control plane protocol signals 204-1-n and the first set of user plane protocol signals 206-1-q to a second set of user plane protocol signals 208-1-r. The convergence gateway 106 may convert the first set of control plane protocol signals 202-1-m from an IETF standard to the second set of control plane protocol signals 204-1-n from a 3GPP standard, and the first set of user plane protocol signals 206-1-q from the IETF standard to the second set of user plane protocol signals 208-1-r from the 3GPP standard. The embodiments are not limited in this context.

In one embodiment, for example, the convergence gateway 106 may send the second set of control plane protocol signals 204-1-n and the second set of user plane protocol signals 208-1-r to the network 114. The convergence gateway 106 may send the second set of control plane protocol signals 204-1-n and the second set of user plane protocol signals 208-1-r to the network 114 over a GRX network, such as the network 108, to access home services provided by the network 114. The embodiments are not limited in this context.

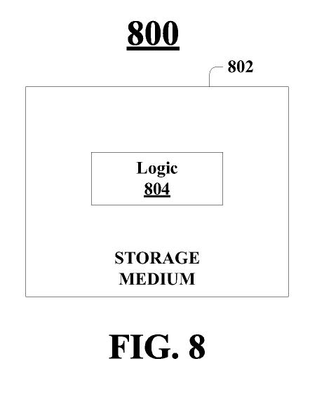

FIG. 8 illustrates one embodiment of an article of manufacture 800. As shown, the article 800 may comprise a storage medium 802 to store logic 804 for performing protocol conversion between IETF protocols and 3GPP protocols in order to facilitate roaming operations for a mobile station over a WiMAX network and a 3GPP network. For example, logic 804 may be used to implement the protocol converter 214, as well as other aspects of the communications system 100. In various embodiments, the article 800 may be implemented by various systems, nodes, and/or modules.

The article 800 and/or machine-readable storage medium 802 may include one or more types of computer-readable storage media capable of storing data, including volatile memory or, non-volatile memory, removable or non-removable memory, erasable or non-erasable memory, writeable or re-writeable memory, and so forth. Examples of a machine-readable storage medium may include, without limitation, random-access memory (RAM), dynamic RAM (DRAM), Double-Data-Rate DRAM (DDR-DRAM), synchronous DRAM (SDRAM), static RAM (SRAM), read-only memory (ROM), programmable ROM (PROM), erasable programmable ROM (EPROM), electrically erasable programmable ROM (EEPROM), Compact Disk ROM (CD-ROM), Compact Disk Recordable (CD-R), Compact Disk Rewriteable (CD-RW), flash memory (e.g., NOR or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, disk (e.g., floppy disk, hard drive, optical disk, magnetic disk, magneto-optical disk), or card (e.g., magnetic card, optical card), tape, cassette, or any other type of computer-readable storage media suitable for storing information. Moreover, any media involved with downloading or transferring a computer program from a remote computer to a requesting computer carried by data signals embodied in a carrier wave or other propagation medium through a communication link (e.g., a modem, radio or network connection) is considered computer-readable storage media.

The article 800 and/or machine-readable medium 802 may store logic 804 comprising instructions, data, and/or code that, if executed by a machine, may cause the machine to perform a method and/or operations in accordance with the described embodiments. Such a machine may include, for example, any suitable processing platform, computing platform, computing device, processing device, computing system, processing system, computer, processor, or the like, and may be implemented using any suitable combination of hardware and/or software.

The logic 804 may comprise, or be implemented as, software, a software module, an application, a program, a subroutine, instructions, an instruction set, computing code, words, values, symbols or combination thereof. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, such as C, C++, Java, BASIC, Perl, Matlab, Pascal, Visual BASIC, assembly language, machine code, and so forth. The embodiments are not limited in this context. When implemented the logic 804 is implemented as software, the software may be executed by any suitable processor and memory unit.

Numerous specific details have been set forth herein to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

Various embodiments may be implemented using hardware elements, software elements, or a combination of both. Examples of hardware elements may include any of the examples as previously provided for a logic device, and further including processors, microprocessors, circuits, circuit elements (e.g., transistors, resistors, capacitors, inductors, and so forth), integrated circuits, logic gates, registers, semiconductor device, chips, microchips, chip sets, and so forth. Examples of software elements may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

It is also worthy to note that any reference to “one embodiment” or “an embodiment” means that a particular feature, structure, or characteristic described in connection with the embodiment is included in at least one embodiment. Thus, appearances of the phrases “in one embodiment” or “in an embodiment” in various places throughout the specification are not necessarily all referring to the same embodiment. Furthermore, the particular features, structures or characteristics may be combined in any suitable manner in one or more embodiments.

While certain features of the embodiments have been illustrated as described herein, many modifications, substitutions, changes and equivalents will now occur to those skilled in the art. It is therefore to be understood that the appended claims are intended to cover all such modifications and changes as fall within the true spirit of the embodiments.

1. An apparatus comprising a convergence gateway having a protocol converter, the protocol converter to receive as input a first set of control plane protocol signals and a first set of user plane protocol signals from a first network, convert the first set of control plane protocol signals to a second set of control plane protocol signals and the first set of user plane protocol signals to a second set of user plane protocol signals, and to send as output the second set of control plane protocol signals and the second set of user plane protocol signals to a second network.

2. The apparatus of claim 1, the first set of control plane protocol signals and the first set of user plane protocol signals defined by an internet engineering task force standard.

3. The apparatus of claim 1, the first set of control plane protocol signals and the first set of user plane protocol signals defined by an mobile internet protocol standard.

4. The apparatus of claim 1, the second set of control plane protocol signals and the second set of user plane protocol signals defined by a third generation partnership project standard.

5. The apparatus of claim 1, the second set of control plane protocol signals and the second set of user plane protocol signals defined by a third generation partnership project standard general packet radio service tunneling protocol.

6. The apparatus of claim 1, the first network comprising an institute of electrical and electronics engineers 802.16 working group and the worldwide interoperability for microwave access forum network.

7. The apparatus of claim 1, the second network including a gateway general packet radio services support node and a home services server to provide home services to a mobile station.

8. The apparatus of claim 1, comprising a mobile station to roam between the first network and the second network, the mobile station to access home services from the second network using the convergence gateway.

9. The apparatus of claim 1, comprising a general packet radio services roaming exchange network to communicate the second set of control plane protocol signals and the second set of user plane protocol signals from the convergence gateway to the second network.

10. The apparatus of claim 1, comprising:
a processor; and
a memory unit comprising a static random access memory unit, the memory unit to store the protocol converter for execution by the processor.

11. A method comprising:
receiving a first set of control plane protocol signals and a first set of user plane protocol signals from a first network;
converting the first set of control plane protocol signals to a second set of control plane protocol signals and the first set of user plane protocol signals to a second set of user plane protocol signals; and
sending the second set of control plane protocol signals and the second set of user plane protocol signals to a second network.

12. The method of claim 11, comprising receiving the first set of control plane protocol signals and the first set of user plane protocol signals from a roaming subscriber mobile station.

13. The method of claim 11, comprising sending the second set of control plane protocol signals and the second set of user plane protocol signals to the second network over a general packet radio services roaming exchange network.

14. The method of claim 11, comprising sending the second set of control plane protocol signals and the second set of user plane protocol signals to the second network over a general packet radio services roaming exchange network to access home services provided by the second network.

15. The method of claim 11, comprising converting the first set of control plane protocol signals from an internet engineering task force standard to a second set of control plane protocol signals from a third generation partnership project standard, and the first set of user plane protocol signals from the internet engineering task force standard to a second set of user plane protocol signals from the third generation partnership project standard.

16. An article comprising a computer-readable storage medium containing instructions that if executed enable a system to:
receive a first set of control plane protocol signals and a first set of user plane protocol signals from a first network;
convert the first set of control plane protocol signals to a second set of control plane protocol signals and the first set of user plane protocol signals to a second set of user plane protocol signals; and
send the second set of control plane protocol signals and the second set of user plane protocol signals to a second network.

17. The article of claim 16, further comprising instructions that if executed enable a system to receive the first set of control plane protocol signals and the first set of user plane protocol signals from a roaming subscriber mobile station.

18. The article of claim 16, further comprising instructions that if executed enable a system to send the second set of control plane protocol signals and the second set of user plane protocol signals to the second network over a general packet radio services roaming exchange network.

19. The article of claim 16, further comprising instructions that if executed enable a system to send the second set of control plane protocol signals and the second set of user plane protocol signals to the second network over a general packet radio services roaming exchange network to access home services provided by the second network.

20. The article of claim 16, further comprising instructions that if executed enable a system to convert the first set of control plane protocol signals from an internet engineering task force standard to a second set of control plane protocol signals from a third generation partnership project standard, and the first set of user plane protocol signals from the internet engineering task force standard to a second set of user plane protocol signals from the third generation partnership project standard.
